(19) United States
(12) Patent Application Publication
(10) Pub. No.: US 2025/0310326 A1
(43) Pub. Date: Oct. 2, 2025

(54) SYSTEMS AND METHODS FOR INTELLIGENT REAL-TIME KYC IDENTITY VERIFICATION USING GOVERNMENT ISSUED DOCUMENTS AND BIOMETRIC MATCHING

(71) Applicant: CELLIGENCE INTERNATIONAL LLC, Guaynabo, PR (US)

(72) Inventors: Pavan AGARWAL, DORADO, PR (US); Jonathan Ortiz RIVERA, SAN JUAN, PR (US); Gabriel Albors SANCHEZ, SAN JUAN, PR (US)

(73) Assignee: CELLIGENCE INTERNATIONAL LLC, Guaynabo, PR (US)

(21) Appl. No.: 19/234,089

(22) Filed: Jun. 10, 2025

Related U.S. Application Data
(63) Continuation-in-part of application No. 16/993,148, filed on Aug. 13, 2020.
Application No. 16/993,148 is a continuation-in-part of application No. 15/706,590, filed on Sep. 15, 2017, now abandoned.

(51) Int. Cl. H04L 9/40; G06Q 50/00; G06V 40/16; G06V 40/20

(52) U.S. Cl. CPC H04L 63/0861; G06Q 50/01; G06V 40/172; G06V 40/20; H04L 63/0853

(57) ABSTRACT

According to various embodiments, a system and method for verifying a user's identity using both document-based and biometric data is disclosed. The system may prompt a user to upload an image of a government-issued identification document and extract user information from the image using optical character recognition (OCR). The system may also extract the embedded face image from the ID and prompt the user to take a real-time selfie while performing one or more randomized actions or poses. A facial recognition engine may compare the extracted ID image to the live selfie to determine a similarity score. Based on this match, along with optional document authenticity checks, the system may confirm the user's identity in real-time for use cases such as account access, onboarding, and regulatory KYC compliance.

### RELATED APPLICATIONS

This application a continuation-in-part of U.S. patent application Ser. No. 16/993,148, filed on Aug. 13, 2020, which was a continuation-in-part of U.S. patent application Ser. No. 15/706,590, filed on Sep. 15, 2017, each of which is hereby incorporated herein by reference in the respective entirety.

### TECHNICAL FIELD

The present disclosure relates generally to identity verification systems, and more particularly to systems and methods for verifying user identity in real time using biometric analysis and government-issued identification documents. In particular, the disclosed technology relates to intelligent Know Your Customer (KYC) verification systems that combine document image analysis, facial recognition, and real-time user interaction to authenticate identity in remote digital environments.

### BACKGROUND

With the widespread adoption of digital platforms for banking, e-commerce, and identity-sensitive services, verifying a user's identity remotely has become both a technical and regulatory necessity. Many institutions are required to comply with Know Your Customer (KYC) and Anti-Money Laundering (AML) regulations, which often mandate verification of government-issued identification documents and confirmation that the person presenting the document is its rightful owner.

Traditionally, online identity verification processes have involved manual review of uploaded identification documents or reliance on static profile pictures. These approaches are prone to manipulation and fraud. A user could submit someone else's ID, or alter an image to resemble a stolen credential. As a result, static verification methods offer limited security, particularly in high-risk or regulated environments.

More advanced systems now request both an image of a government-issued ID and a live selfie to confirm user identity. However, these implementations often depend on human review, are slow to scale, or lack real-time automation. Further challenges arise in ensuring that the ID is legitimate, extracting information from a variety of ID formats, and verifying that the user taking the selfie matches the person in the ID.

Accordingly, there is a need for systems and methods that can automatically extract user data from identification documents, isolate and compare facial images using facial recognition, and validate identity in real time. Such systems must account for the dynamic nature of modern identity threats, as well as the evolving demands of compliance, fraud prevention, and user experience.

The present disclosure addresses these challenges by expanding identity verification beyond traditional static checks, introducing a real-time process that combines document analysis, biometric authentication, and AI-driven decision-making to securely confirm user identity based on both document and selfie data.

### SUMMARY

In addition to the real-time pose-based identity verification methods already described, the present disclosure further includes embodiments for verifying a user's identity using a government-issued ID document. In these embodiments, the system prompts the user to upload an image of a valid ID (e.g., driver's license or passport). The system extracts textual user information from the ID using OCR, and isolates the facial image embedded in the ID using image segmentation. The user is then prompted to submit a live selfie that meets one or more randomly selected pose instructions.

The extracted facial image from the ID is then compared to the real-time selfie using facial recognition software. A similarity score is generated and used to determine whether the user's identity has been verified. Optional embodiments may also include document authenticity analysis, integration with third-party identity verification services, or storage of verification metadata for audit purposes. These workflows enhance the security and usability of the platform while supporting onboarding, KYC, or fraud detection.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example architecture for verifying the identity of a user associated with an account, according to an implementation of the disclosure.

FIG. 2 illustrates a high-level process flow for real-time identity verification using a government-issued document and biometric matching, according to an implementation of the disclosure.

FIG. 3 illustrates a workflow for analyzing a submitted identification document, including layout-based parsing and extraction of facial imagery and text regions, according to some embodiments of the disclosed technology.

FIG. 4 illustrates a process flow for validating a user's pose and performing facial recognition or fallback biometric verification using a real-time selfie image, according to an implementation of the disclosure.

FIG. 5 illustrates a process flow for performing voice-based user verification, according to an implementation of the disclosure.

FIG. 6 illustrates a process flow for aggregating identity verification results from multiple modalities and generating a final decision, according to an implementation of the disclosure.

FIG. 7 illustrates a process flow for handling identity verification sessions flagged for manual review, according to an implementation of the disclosure.

FIG. 8 illustrates a process flow for selecting and executing an adaptive verification input method, according to an implementation of the disclosure.

FIG. 9 illustrates a process flow for capturing and finalizing an audit log entry following an identity verification decision according to an implementation of the disclosure.

FIG. 10 illustrates a process flow for validating an identity verification input using one or more external resource systems, according to an implementation of the disclosure.

FIG. 11 illustrates an example computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Described herein are systems and methods for intelligently automating the process of verifying a user's identity. The following disclosure sets forth various example embodiments, which illustrate the features and functionalities of the described technology. Additional objects, advantages, and features will be apparent to those skilled in the art from the detailed description, accompanying drawings, examples, and claims. All such systems, methods, and improvements are intended to fall within the scope of the present disclosure and to be protected by the appended claims.

As alluded to above, social media is often used by people pretending to be someone else by using images and information from accounts of others. Commonly, this is done for some illicit purpose and takes advantage of inability to verify identity. That is, is often impossible to spot a fake account, leading the users willingly sharing information and even transferring funds to people whose identity is unknown. While there are services that allow reverse image searches to help verify if particular image is associated with other accounts, such verification requires first recognizing that a user may be posing as someone else. Secondly, such verification is tedious and time consuming and often provides incomplete results.

Embodiments of the disclosed technology provide a platform-agnostic system for real-time account verification and identity confirmation. A user account or profile may be associated with a wide variety of online platforms, including but not limited to social media networks, online gaming communities, messaging applications, and commercial platforms such as online banking, digital wallets, and e-commerce services.

In some embodiments, the user profile may contain personal identifying information such as the user's name, age, gender, date of birth, contact details, occupation, or education history. This information may include both publicly visible data and private account metadata. The user profile may also include a current or representative image of the user to serve as a profile picture, depending on the requirements of the hosting platform.

The verification system may include one or more machine learning models configured to assess whether a given account should undergo identity verification based on a predefined set of criteria. For example, the system may flag newly created accounts, accounts with limited user connections, or accounts that initiate unsolicited communication with others. Additionally, the system may consider geolocation activity and identify devices logging in from unfamiliar or previously unused geographic regions to determine whether verification should be triggered.

Upon identifying an account requiring further verification, the system may initiate a verification workflow, prompting the user to submit one or more real-time images or videos. These may include specific pose instructions, hand gestures, or facial expressions to ensure that the images are live and not recycled or stolen. The system may then evaluate the submitted content using facial recognition algorithms to confirm that the user depicted in the new image is consistent with images already associated with the account. Furthermore, the system may check that the user is not known to be associated with other unrelated accounts or known impersonation attempts. In certain embodiments, the verification instructions may be selected dynamically to introduce poses or gestures not previously present in the user's image history, further enhancing spoof resistance and identity confidence.

In certain embodiments, the verification system may be configured to satisfy Know Your Customer (KYC) or other regulatory identity verification requirements. In such embodiments, the system may prompt the user to upload an image of a government-issued identification document, such as a passport, driver's license, or national ID card. The system may use optical character recognition (OCR) to extract user information from the document, including the user's name, date of birth, ID number, and expiration date. In parallel, the system may isolate the facial image embedded within the ID document using document layout analysis or computer vision segmentation. This extracted image may then be compared to a verification image captured in real time through the user's device, such as a selfie taken in response to a prompt including one or more randomized poses or gestures. A facial recognition module may determine a similarity score between the face in the ID and the face in the real-time image. The system may then verify the user's identity based on this similarity score, optionally in combination with document authenticity checks, OCR confidence levels, and pose compliance. In some embodiments, failed matches or suspicious documents may trigger a secondary verification process or flag the user account for manual review.

In some embodiments, the system may be further integrated with one or more external identity verification or compliance services. For example, the system may transmit extracted document data, such as the ID number or issuing authority, to a third-party KYC provider or government registry for validation of document authenticity. Additional external resources may include fraud detection APIs that evaluate document structure, verify embedded metadata, or assess image integrity using forensic techniques. The system may also query sanctions lists, politically exposed persons (PEP) databases, or adverse media screening services to determine whether the verified individual is subject to enhanced due diligence requirements. Results from these external checks may be incorporated into an overall verification score or used to automatically approve, reject, or escalate the user account for further review. In certain embodiments, the system may log all verification inputs and outcomes in a secure audit trail to support downstream compliance reporting and regulatory audits.

Conventional identity verification systems often rely on static image comparison, manual document review, or knowledge-based authentication (e.g., security questions). These approaches are prone to spoofing, error-prone under poor lighting or image quality, and are not adaptable to user accessibility needs.

Moreover, many existing systems fail to account for user-specific behavior or fallback conditions when primary verification steps fail. They lack integrated workflows for adaptive input (e.g., motion- or voice-based alternatives) and offer limited auditability. External resource queries, when used, are typically non-contextual and siloed from the identity decision logic.

The present disclosure addresses these limitations by integrating multi-modal verification, pose compliance checks, fallback logic, real-time decision aggregation, and audit traceability in a cohesive, extensible architecture.

The disclosed system provides specific technical improvements over conventional identity verification methods in several respects. Unlike static ID upload workflows or knowledge-based authentication, the system integrates real-time pose-aware facial verification with adaptive fallback logic, enabling more secure and inclusive identity confirmation.

The system improves biometric spoof detection by analyzing user compliance with randomized pose instructions and by detecting behavioral inconsistencies through facial and voice liveness analysis. These technical measures reduce false positives associated with photo-based spoofing and prerecorded video attacks.

Additionally, the system offers a modular verification pipeline that includes fallback input modalities-such as voice-based reading tasks or motion-based gestures-when pose compliance fails. This allows for robust and accessible identity verification, especially for users with limited mobility or facial impairment.

From a system architecture standpoint, the invention enables distributed verification using multiple independently evaluated modalities (e.g., face match, voice match, document authenticity), each with configurable weights and thresholds. The results are aggregated in a decision engine that produces a composite verification outcome.

Further, the system logs verification steps, extracted features, and fallback paths to an audit database with verifiable integrity. This improves transparency, facilitates compliance with regulatory frameworks (e.g., KYC/AML), and supports traceability in automated decisions-capabilities not available in traditional systems.

These improvements collectively enhance identity verification performance, scalability, accessibility, and trustworthiness, and are implemented using specific computing mechanisms beyond generic data manipulation.

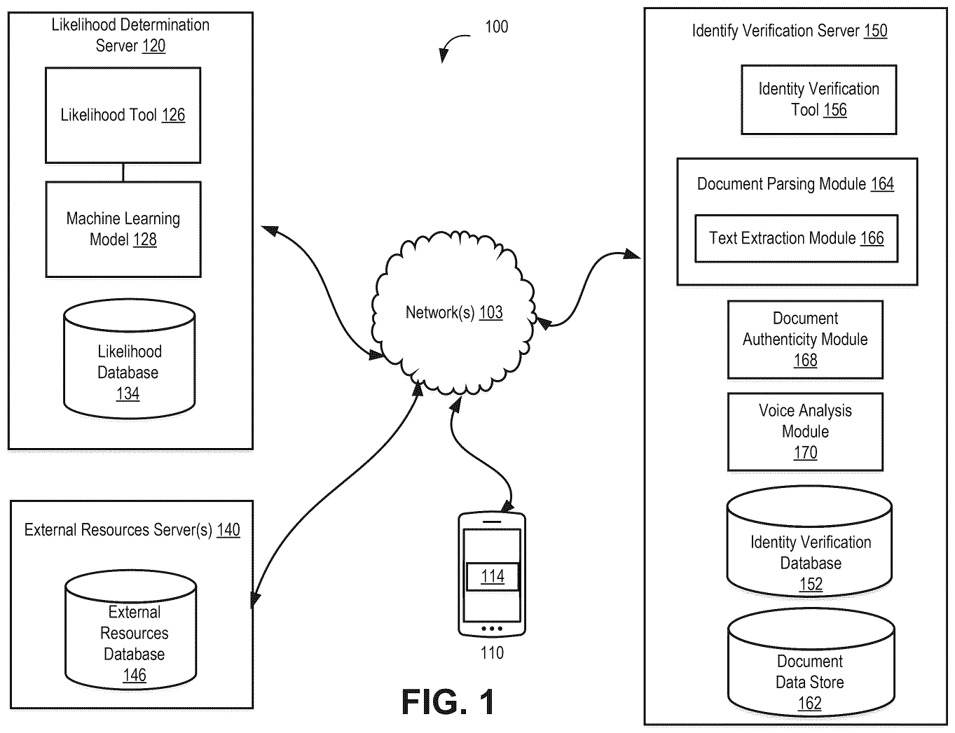

FIG. 1 illustrates an automated user identity verification system 100 according to some embodiments of the disclosed technology. System 100 may include a likelihood determination server 120, an identity verification server 150, an external resources server 140, a network 103, and a user computing device 110 (e.g., a mobile phone or tablet device with a display 114) associated with a user. These components may be interconnected via one or more networks 103. In some embodiments, the system also includes various software modules and data stores that support identity risk scoring, document parsing, biometric verification, and optional voice-based interaction analysis. Additionally, system 100 may include additional networking components such as one or more routers, switches, or gateways. In some embodiments, the system may support identity verification across a range of applications, including but not limited to social media platforms, financial services, e-commerce systems, and other platforms requiring secure user authentication.

The user computing device 110 may be any electronic device capable of capturing and transmitting image, video, and audio data, such as a smartphone, tablet, wearable device, or computing terminal. In the illustrated embodiment, the user device includes a display 114 configured to present prompts (e.g., pose instructions, document capture guides) and capture real-time media as part of the identity verification process.

In some embodiments, likelihood determination server 120 is configured to evaluate whether a user account is potentially fraudulent, synthetic, or otherwise suspicious. Likelihood determination server 120 may include a likelihood tool 126, which analyzes profile attributes, behavioral signals, and contextual metadata to calculate a likelihood score indicating whether the account should be flagged for identity verification. In some cases, this score may be used to trigger downstream actions by the identity verification server 150.

Likelihood tool 126 may include a suite of algorithms configured to analyze one or more of the following: user-provided biographical information, location history, connection graphs (e.g., social or transaction-based), recent communication patterns, and account creation metadata. For example, if a new user account is created from an IP address or geolocation not previously associated with that user, or if the account initiates a connection to a large number of unconnected users, the system may increase the suspicion score. Tool 126 may be implemented as a rules engine, a machine learning model, or a hybrid combination thereof.

In some embodiments, the likelihood determination server 120 may be coupled to or include a likelihood database 134. This database may store both static profile data (e.g., date of account creation, self-reported attributes) and dynamic behavior data (e.g., login timestamps, connection requests, message frequency). The database may also include output scores and thresholds used to determine whether to initiate identity verification workflows.

In certain embodiments, system 100 may include a machine learning model 128 trained to detect anomalous user behavior or synthetic account characteristics. Model 128 may use inputs such as, similarity between new user profiles and known bad actors, velocity of user actions (e.g., friend requests per hour), inconsistency between claimed and derived location or device usage, and biometric mismatch between uploaded media and prior images.

Model 128 may output a continuous or thresholded suspicion score, which likelihood tool 126 may use to decide whether to route the user to verification.

The output of likelihood tool 126 may be transmitted to the identity verification server 150 to initiate pose-based selfie verification, document upload prompts, or voice analysis workflows. In some embodiments, likelihood tool 126 may also query external resources server(s) 140 for additional signals, such as duplicate account detection, data from known fraud registries, or government watchlist correlation.

In various implementations, likelihood determination server 120 may include configurable thresholds or user-defined risk rules. For example, an administrator may adjust what score level triggers automatic verification, or may assign different verification requirements based on the risk score range. These configurations may be stored locally on server 120 or pulled from a centralized policy store.

The identity verification server 150 is configured to manage and execute the primary verification workflows. It includes an identity verification tool 156, which coordinates document analysis, selfie comparison, and behavioral profiling. In some embodiments, identity verification server 150 includes one or more processing modules described below.

A document parsing module 164 may be configured to receive and analyze images of government-issued identification documents submitted by the user via device 110. The parsing module may identify the layout and structure of the document to isolate key regions such as the embedded facial photo and textual fields. A text extraction module 166 (e.g., based on OCR or barcode/MRZ decoding) may extract user information such as full name, date of birth, document number, and expiration date from the uploaded image. These values may be stored or compared against user-provided data for consistency checks.

A document authenticity module 168 may be used to assess whether the uploaded identification document is likely to be genuine or manipulated. In some embodiments, this module analyzes visual features such as font consistency, security element placement, layout conformity, and glare or artifact detection. The system may also verify structural integrity using known templates or consult external databases for issuing authority verification.

A voice analysis module 170 may optionally be used to collect and process voice input from the user. In some embodiments, the user may be asked to repeat a phrase, read on-screen lyrics, or speak a predefined prompt. The module may extract features such as pitch, pacing, and tone for calibration and may evaluate consistency with previously stored vocal profiles when available. The voice analysis module is designed to be user-calibrated and bias-aware, with opt-in participation and fallback options to gesture- or motion-based interactions for accessibility.

Identity verification database 152 may be used to store structured outputs of the verification process, including facial match scores, pose compliance results, and verification decisions. Document data store 162 may store raw images of uploaded IDs, extracted text data, cropped facial regions, and associated metadata for audit, compliance, and reprocessing purposes.

In some embodiments, machine learning model 128 or a supplemental model executing on identity verification server 150 may be trained to evaluate verification outcomes based on multi-modal inputs, including biometric imagery, document characteristics, and behavioral interaction patterns. The model may generate adaptive confidence scores or trigger fallback authentication workflows as needed.

In some embodiments, the memory of identity verification server 150 may store application(s) including executable instructions that, when executed, cause the server to perform operations for user identity verification. The identity verification server 150 may include an identity verification tool 156, which may orchestrate a combination of biometric matching, document analysis, and optional behavioral profiling. In some implementations, identity verification tool 156 may include submodules such as a document parsing module 164, a text extraction module 166, a document authenticity module 168, and a voice analysis module 170. These modules may work in coordination to evaluate identity evidence from various user-provided inputs.

Identity verification tool 156 may be configured to validate a user's identity using one or more verification inputs, such as real-time images, document uploads, or speech-based interaction. In some embodiments, tool 156 may analyze the alignment between a government-issued ID image and a live selfie, verify the structural integrity of the ID, and optionally assess consistency of a user's vocal characteristics if voice input is enabled. In some cases, identity verification tool 156 may also be configured to allow a user (e.g., a system administrator or third-party verifier) to manually confirm identity using captured media and system-generated confidence scores.

In some embodiments, likelihood determination server 120 and identity verification server 150 may each include a processor, memory, and communication interface, and may be implemented as physical or virtual servers. In some embodiments, likelihood determination server 120 and identity verification server 150 may each be a hardware server. In some implementations, likelihood determination server 120 and identity verification server 150 may each be provided in a virtualized environment, e.g., likelihood determination server 120 and/or identity verification server 150 may be a virtual machine that is executed on a hardware server that may include one or more other virtual machines. Additionally, in one or more embodiments of this technology, virtual machine(s) running on likelihood determination server 120 and/or identity verification server 150 may be managed or supervised by a hypervisor. Likelihood determination server 120 and identity verification server 150 may be communicatively coupled to network 103.

In some embodiments, likelihood determination server 120 and identity verification server 150 may each be a standalone device or integrated with one or more other devices or apparatuses, such as one or more of the storage devices, for example. For example, likelihood determination server 120 and identity verification server 150 may each include or be hosted by one of the storage devices, and other arrangements are also possible.

In some embodiments, external resources server(s) 140 may be configured to store or retrieve resource data associated with a user from sources external to system 100. This may include data related to accounts the user may hold on other platforms (e.g., social media, banking apps, email providers), or identity-related records available through open-source intelligence. External resources server(s) 140 may also interface with disparate third-party services, such as public record databases, credit bureaus, law enforcement registries, fraud intelligence services, financial compliance systems, or governmental identity verification APIs. The information retrieved from these sources may be used by likelihood determination server 120 and/or identity verification server 150 when calculating a risk score or verifying the authenticity of a submitted identity.

In some embodiments, external resources server(s) 140 may comprise one or more computing systems capable of interfacing with likelihood determination server 120, likelihood database 134, identity verification database 152, client device 110, and other components within or outside system 100. The external resources server(s) may include a processor, memory, and a communication interface coupled via a data bus. In some embodiments, external resources server(s) 140 may maintain a local or distributed external resources database 146, which may store retrieved records, reference templates, metadata, or normalized data received from third-party services. These records may be used for pattern recognition, watchlist comparison, or issuing-authority validation during the identity verification process.

In certain embodiments, external resources server(s) 140 may access regulatory or compliance-focused services to assist with real-time KYC validation. This may include validating the issuing authority of a government-issued ID, checking whether a document number is consistent with known formats, or determining whether a user is present on a politically exposed person (PEP) list, sanctions list, or other exclusionary database. Responses from these systems may be logged, scored, or presented to the identity verification server 150 for additional review or audit tracking.

To support flexible integrations, external resources server(s) 140 may include adapters or API clients for interfacing with heterogeneous third-party systems. In some embodiments, the server normalizes incoming data (e.g., mapping field names, translating formats, timestamp alignment) before storing results in external resources database 146. Normalized records may include document metadata, known aliases, issuing jurisdiction codes, or source confidence levels. These records may be consumed by the identity verification tool 156 or likelihood tool 126 as part of an extended verification decision.

In some embodiments, likelihood determination server 120, identity verification server 150, external resources servers 140, and or other components may be a single device. Alternatively, a plurality of devices may be used. For example, the plurality of devices associated with external resources servers 140 may be distributed across one or more distinct network computing devices that together comprise one or more external resources servers 140.

In some embodiments, the components shown as separate servers (e.g., likelihood determination server 120, identity verification server 150, external resources servers 140) may be implemented as distributed systems. Each server may consist of a plurality of networked devices operating under a shared control protocol, such as a master/slave configuration, cluster controller, or load balancer. In some embodiments, likelihood determination server 120, identity verification server 150, external resources servers 140 may not be limited to a particular configuration. Thus, in some embodiments, likelihood determination server 120, identity verification server 150, external resources servers 140 may contain a plurality of network devices that operate using a master/slave approach, whereby one of the network devices operate to manage and/or otherwise coordinate operations of the other network devices. Additionally, in some embodiments, likelihood determination server 120, identity verification server 150, external resources servers 140 may comprise different types of data at different locations.

In some embodiments, likelihood determination server 120, external resources servers 140, identity verification server 150 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary system 100 with payor computing device 104, provider device 105, likelihood determination server 120, identity verification server 150, external resources servers 140, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as payor computing device 104, provider device 105, likelihood determination server 120, identity verification server 150, external resources servers 140 may be configured to operate as virtual instances on the same physical machine. In other words, one or more of payor computing device 104, provider device 105, likelihood determination server 120, identity verification server 150, external resources servers 140 may operate on the same physical device rather than as separate devices communicating through communication network(s). Additionally, there may be more or fewer devices than payor computing device 104, provider device 105, likelihood determination server 120, identity verification server 150, and external resources servers 140.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intranets, and combinations thereof.

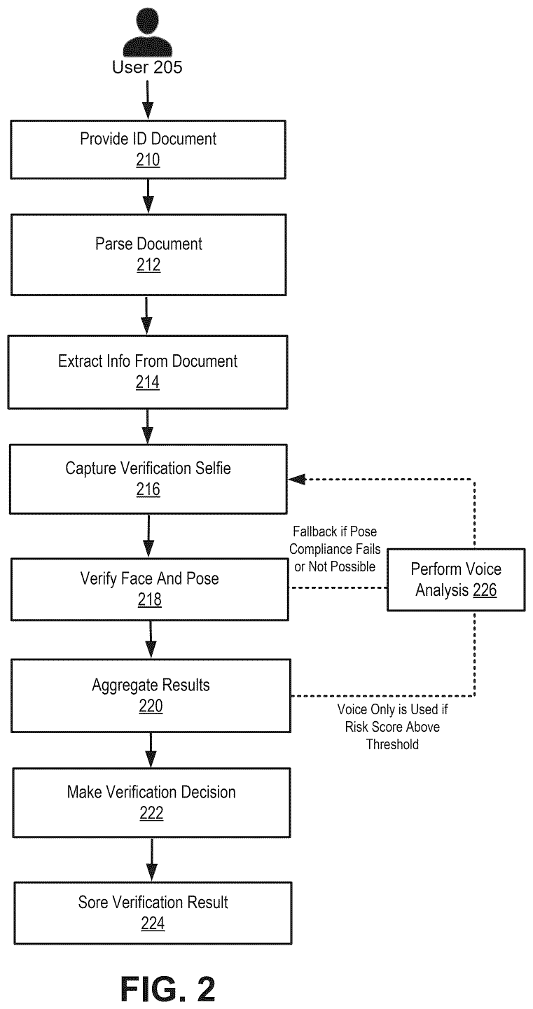

FIG. 2 illustrates a high-level process flow for real-time identity verification using a government-issued document and biometric matching, according to some embodiments of the disclosed technology.

The process begins when a user, via client device 110, initiates a verification sequence by uploading an image of a government-issued identification document (step 210). The client device 110 transmits this document image to identity verification server 150 via network 103.

Upon receipt, the identity verification tool 156 invokes document parsing module 164 to analyze the structure of the submitted document (step 212). Layout-specific logic may be used to identify expected regions, including a facial image zone and text-based identity fields. The extracted textual regions are passed to text extraction module 166 (step 214), which uses optical character recognition (OCR) or similar methods to extract the user's name, date of birth, document number, and other relevant fields. In parallel, the facial image from the document is isolated and prepared for biometric comparison.

Next, the system prompts the user to capture a live verification selfie in accordance with one or more randomized pose instructions (step 216). These instructions may be displayed via display 114 of client device 110 and may include actions such as turning the head, smiling, or blinking. The client device 110 captures the selfie image and transmits it back to identity verification server 150.

The selfie is then evaluated by the identity verification tool 156. Pose compliance is verified (step 218), and facial recognition is performed to compare the real-time selfie image against the facial image extracted from the ID. A similarity score is generated and stored.

Voice analysis module 170 may be invoked under two conditions: (1) as a fallback if pose compliance fails or is not feasible due to accessibility constraints, or (2) if the user's risk score exceeds a predefined threshold after initial aggregation. In either case, the user may be prompted to speak or read a phrase, and the system analyzes pitch, cadence, and other vocal features for consistency with any prior profile (step 226).

Once all individual analyses are complete, the identity verification tool 156 aggregates the results, including document authenticity scores (from module 168), facial match confidence, pose compliance results, and optional voice profile consistency (step 220). These are synthesized into a final verification decision (step 222), which may include approval, rejection, or escalation for manual review. The system may store the verification results in identity verification database 152 and document data store 162 for audit, compliance, or re-verification purposes (step 224).

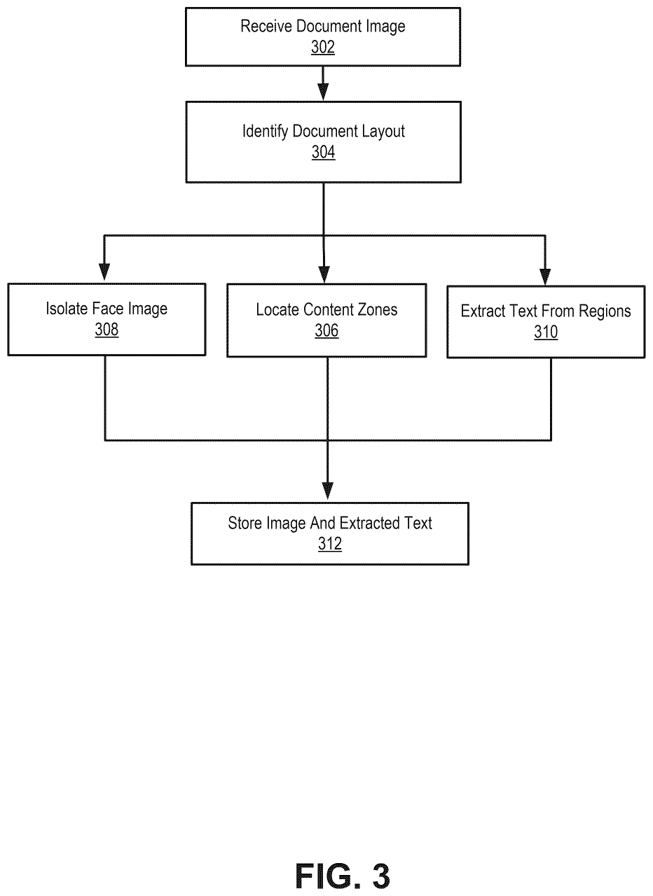

FIG. 3 illustrates a workflow for analyzing a submitted identification document, including layout-based parsing and extraction of facial imagery and text regions, according to some embodiments of the disclosed technology.

The process begins when identity verification server 150 receives an image of a government-issued identification document from client device 110 (step 302). The image is passed to document parsing module 164, which identifies the layout and structure of the document (step 304). In some embodiments, this includes determining the type and issuing authority of the document, such as whether it is a passport, driver's license, or national ID, and identifying expected zones for name, date of birth, photograph, and other fields.

Once the layout is recognized, the system proceeds to locate content zones (step 306), which may include bounding boxes around both the embedded face image and text-containing fields. This process may be based on predefined templates, visual segmentation techniques, or machine learning models trained to recognize document layouts.

Two operations may occur in parallel or independently following zone identification. First, the system isolates the face image from the photo region of the document (step 308). This facial image may later be compared to a live selfie image during the identity verification process. Second, the system extracts text from the identified fields using text extraction module 166 (step 310). Optical character recognition (OCR), barcode decoding, or MRZ (machine-readable zone) parsing may be used to extract the user's name, date of birth, ID number, and other identifying data.

The results of both operations—the isolated facial image and the extracted text—are transmitted to the document data store 162 for structured storage and made available to downstream components such as facial recognition or authenticity scoring. These outputs may also be logged for audit or regulatory compliance (step 312).

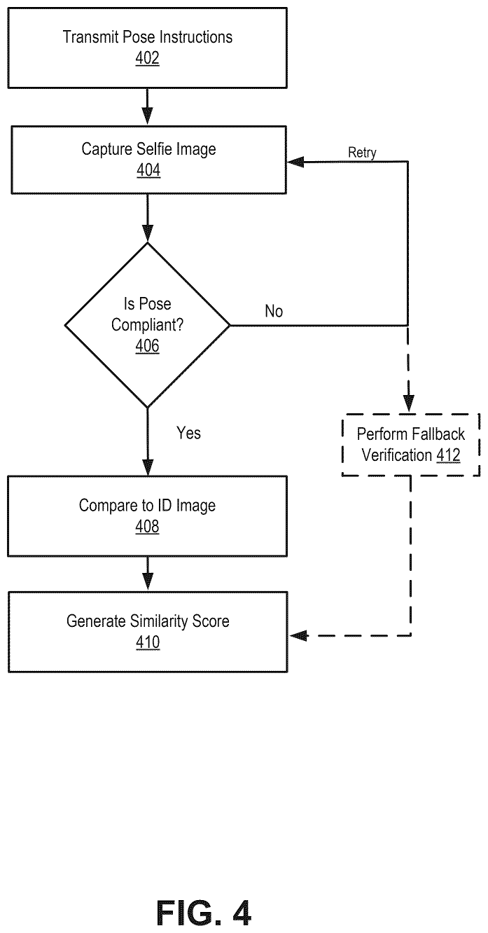

FIG. 4 illustrates a process flow for validating a user's pose and performing facial recognition or fallback biometric verification using a real-time selfie image, according to some embodiments of the disclosed technology.

The process begins after a government-issued ID has been received and processed. Identity verification server 150 transmits a pose instruction to client device 110 (step 402). The instruction may be randomized and may include commands such as “tilt head to the right,” “raise eyebrows,” “smile slightly,” or “blink twice.” These instructions may be displayed via display 114, and are designed to ensure liveness and detect attempted spoofing using pre-recorded or synthetic media.

In response, the user captures a selfie image using the client device 110 (step 404), which is transmitted to the identity verification server. Identity verification tool 156 evaluates the image to determine whether the pose was performed correctly (step 406). Pose compliance may be determined using facial landmark analysis, head orientation estimation, and expression pattern recognition.

If the pose is compliant, the captured selfie is passed to the facial comparison engine, where it is compared to the facial image extracted from the uploaded ID (step 408). A similarity score is computed (step 410) using feature-based or neural network-based comparison models.

If the pose is not compliant, the system may take one of two actions. First, the user may be prompted to retry the selfie capture step (return to 404). This allows for multiple attempts to achieve the required pose. Second, the system may optionally invoke a fallback verification pathway (step 412). This may include a voice-based challenge (e.g., reading aloud a sentence), a gesture-based motion challenge using device sensors, or another biometric modality such as touch dynamics or video gesture tracking.

Fallback verification module 412 may generate an alternative similarity score based on behavioral or biometric analysis, and transmit that score to the main identity verification tool for aggregation (step 410). In some embodiments, similarity score 410 may reflect confidence from a single source (e.g., face match) or a weighted combination of sources (e.g., face+voice, or pose+voice consistency). These scores are passed downstream for final aggregation and decision-making as described with reference to FIG. 2.

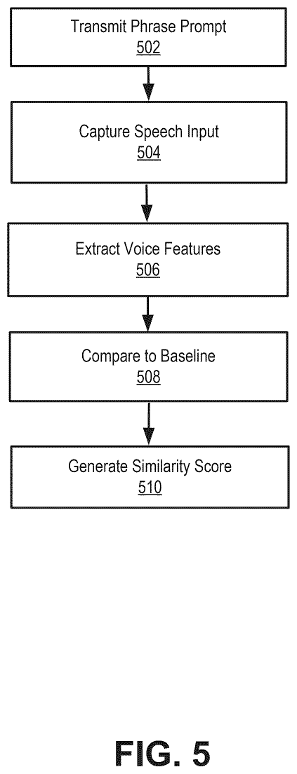

FIG. 5 illustrates a process flow for performing voice-based user verification, according to some embodiments of the disclosed technology. This process may occur as an alternative to or in conjunction with facial recognition when pose-based verification is unavailable, failed, or bypassed for accessibility or user preference.

The process begins when the identity verification server 150 transmits a prompt to client device 110 requesting the user to speak or read a predetermined phrase (step 502). This may be a random string, a set of digits, or a known sentence. The prompt may be text-based, audio-based, or visually displayed depending on system configuration and accessibility mode.

The client device 110 captures the user's speech (step 504) and transmits the recorded audio to the voice analysis module 170. In some embodiments, the system may also capture additional metadata such as ambient noise levels or timestamp information for integrity checks.

The voice analysis module 170 extracts acoustic features from the received voice sample (step 506). These may include pitch, spectral energy distribution, cadence, pause patterns, and vocal signature characteristics such as MFCCs (Mel Frequency Cepstral Coefficients). The system may also analyze delivery confidence, speaking rate, and pronunciation style for behavioral profiling.

If the user has a prior voice baseline on file, the voice analysis module 170 compares the extracted acoustic features to the stored baseline (step 508). This baseline may have been created during an initial enrollment process, during a prior verified session, or gradually accumulated from user interactions over time. The baseline may include pitch range, spectral profile (e.g., MFCCs), cadence, and other biometric or behavioral vocal signatures. If a baseline is unavailable—for example, during first-time verification—the system may apply a general fraud detection model or use pre-trained thresholds to detect anomalies, impersonation attempts, or synthetic speech. In some embodiments, users may optionally calibrate their voiceprint during onboarding or via a settings interface to improve verification accuracy and enable emotion-aware interaction features.

A similarity or confidence score is generated (step 510), which may reflect both biometric match and behavioral consistency. In some embodiments, the system may also assess emotional tone (e.g., signs of duress or stress) if the user has explicitly opted in. This score is then passed to the aggregation module (e.g., step 410 of FIG. 4 or step 220 of FIG. 2) for inclusion in the final verification decision.

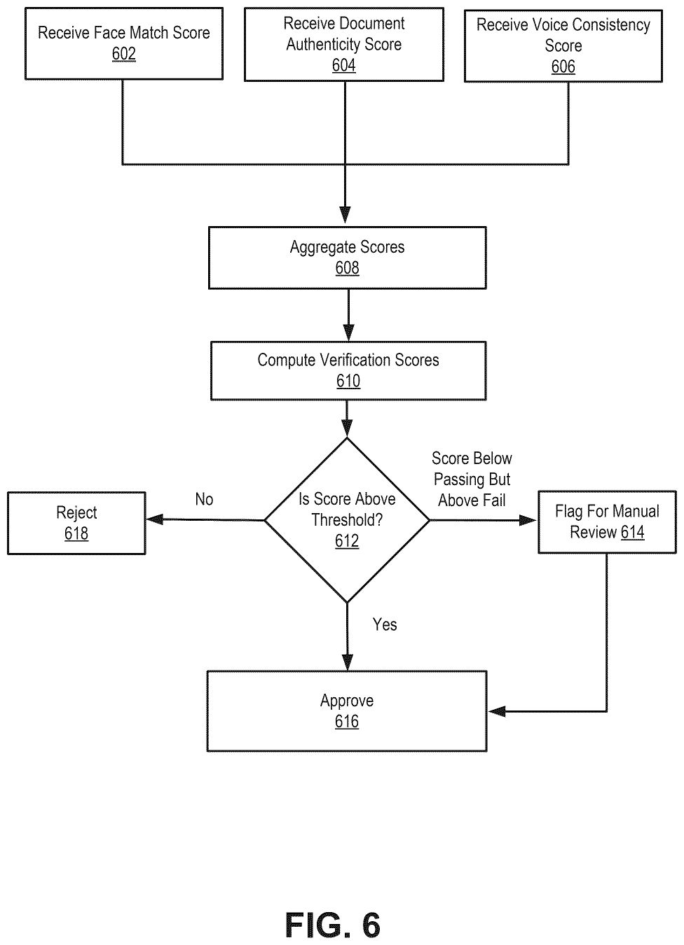

FIG. 6 illustrates a process flow for aggregating identity verification results from multiple modalities and generating a final decision, according to some embodiments of the disclosed technology. The system is configured to integrate biometric, document, and optional behavioral inputs to compute a weighted verification score, which is evaluated against multiple thresholds to determine whether the user should be approved, rejected, or flagged for manual review.

The process begins when the identity verification tool 156 receives three or more independent verification signals. These may include a facial similarity score (step 602), a document authenticity score (step 604), and a voice consistency score (step 606), the latter being optionally included when voice analysis is performed as a fallback or accessibility mechanism. Each of these signals may be produced by specialized modules described in earlier figures (e.g., face comparison module, document authenticity module 168, and voice analysis module 170). The scores are transmitted to the aggregation module for further processing.

At step 608, the identity verification tool 156 aggregates the received scores into a unified evaluation set. Aggregation may involve normalization of scoring scales, weighting based on risk level or configuration, and discarding of unused or unavailable metrics. In some embodiments, weights may be dynamically adjusted based on system policy, user role, or geographic jurisdiction. For example, in regions requiring document-based KYC, the document authenticity score may carry greater weight, whereas in accessibility contexts, voice consistency may be more heavily weighted.

The system computes an overall verification score based on the aggregated inputs (step 610). This may involve applying a linear combination, confidence-weighted average, or neural network output model. At decision step 612, the verification score is evaluated against predefined thresholds.

If the score exceeds a high-confidence acceptance threshold, the user is approved (step 616). If the score falls below a rejection threshold, the user is automatically denied verification (step 618). If the score falls within an intermediate “gray zone”—below the acceptance threshold but above the rejection threshold—the session is flagged for manual review (step 614).

Thresholds may be tunable based on organizational risk tolerance, platform type, or real-time threat levels.

The result of the verification process—whether approval, rejection, or review escalation—is recorded to the identity verification database 152. This may include the aggregated verification score, contributing component scores, any reviewer annotations (for manual outcomes), and a session identifier. The final decision may also trigger downstream actions such as account activation, audit trail creation, alert generation, or retry prompting, depending on platform configuration. Reviewer input may be logged separately and used to refine future verification models or confidence thresholds across the system.

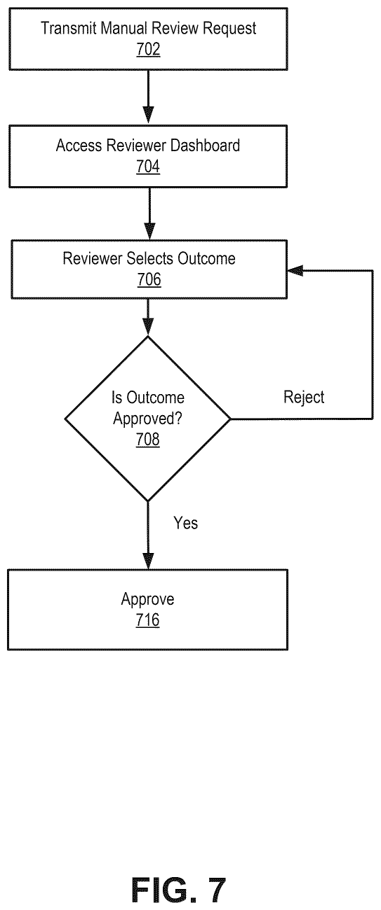

FIG. 7 illustrates a process flow for conducting manual review of a user verification session, according to some embodiments of the disclosed technology. This flow may be triggered when an automated verification score, computed as described with reference to FIG. 6, falls within an intermediate confidence range that does not meet automatic approval or rejection thresholds.

The process begins when the verification engine or decision module transmits a manual review request to a secure reviewer interface (step 702). The request includes relevant session data, including user-submitted media (e.g., document image, selfie image, voice sample), computed scores from various modules (e.g., facial match, document authenticity, voice consistency), and any system-generated flags or notes.

At step 704, a human reviewer accesses the verification session via a secure reviewer dashboard. This dashboard may be hosted within the identity verification server 150 or within a connected compliance portal. The dashboard provides the reviewer with a consolidated view of the session materials, including images, scores, timestamps, and any prior verification attempts.

At step 706, the reviewer selects an outcome based on their evaluation of the evidence. The available options may include “Approve,” “Reject,” or optionally “Escalate” (e.g., for second-level review or fraud investigation). The reviewer may provide a justification for their decision, such as “photo mismatch,” “name discrepancy,” or “voice match acceptable despite pose failure.”

At decision step 708, the system evaluates the selected outcome. If the reviewer's selection is to approve the verification, the system records this approval (step 716), and the user may proceed to account activation, onboarding, or continued access. If the reviewer selects “Reject,” the session may be closed or flagged for fraud alerting, depending on configuration.

In either case, the reviewer's decision, along with their reviewer ID, decision rationale, and timestamp, is logged in identity verification database 152. This log may include a cross-reference to the original automated score, enabling auditability and future reviewer calibration. In some embodiments, reviewer decisions may be fed back into the system to retrain scoring thresholds, improve fallback accuracy, or support compliance audits.

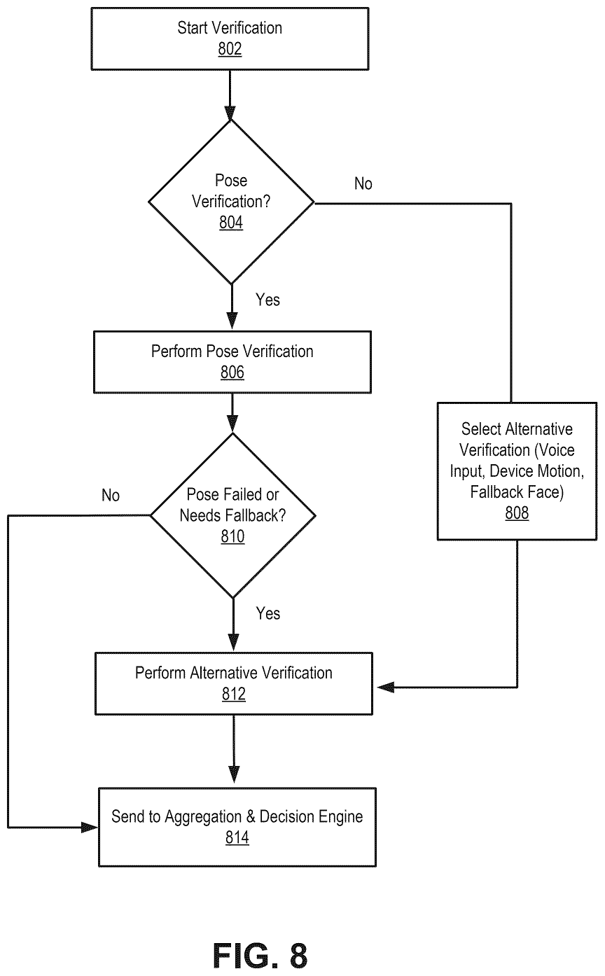

FIG. 8 illustrates a process flow for selecting and executing an adaptive verification input method, according to some embodiments of the disclosed technology. The system may dynamically determine whether pose-based verification is suitable for a given user and, if not, route the session through an alternative verification pathway such as voice input, device motion, or fallback face analysis.

The process begins at step 802, where the system initiates an identity verification session. This may be triggered by a user attempting to onboard to a platform, re-authenticate, or resume a suspended session. The system evaluates the context of the session, including user profile data, device capabilities, prior verification history, and any enabled accessibility settings.

At decision step 804, the system determines whether pose-based selfie verification is appropriate. This determination may consider whether the user's device includes a front-facing camera, whether the user has previously failed pose challenges, or whether the user has opted into accessibility accommodations. If pose verification is feasible, the system proceeds to perform the pose verification (step 806), in which a randomized instruction is issued and the captured selfie is analyzed for pose compliance.

At decision step 810, the system determines whether pose verification has failed or if fallback is otherwise required. This may include cases where the selfie was not compliant with the instructed pose, the user encountered difficulty due to accessibility limitations, or environmental factors (e.g., poor lighting or occlusion) reduce verification confidence. If the system determines that fallback is required, it proceeds to step 808 to select an alternative input method. If the pose verification result is valid and fallback is not required, the system proceeds directly to step 814 to transmit the result to the aggregation and decision engine for scoring and final evaluation.

If fallback is triggered, the system transitions to step 808, where it selects one or more alternative verification methods. These may include voice input, in which the user is prompted to read or repeat a phrase, device motion input, such as tilting or rotating the device in a specified pattern, or fallback facial analysis, using alternative landmarks or previously enrolled face templates with relaxed pose constraints.

The selected fallback method is performed in step 812. The system captures the relevant input (e.g., audio, motion sensor data) and generates a modality-specific verification score, such as voiceprint match confidence or gesture compliance. Once completed, the system proceeds to step 814, where the result is passed to the core verification decision engine for aggregation alongside other available scores (e.g., document authenticity, facial similarity), as described in FIG. 6.

In some embodiments, the system supports accessibility-aware verification pathways. If a user is unable to comply with randomized pose instructions-due to facial paralysis, limited mobility, or other conditions—the system may dynamically substitute alternative input modalities. These may include motion-based gestures (e.g., tilting the device), voice-based prompts (e.g., repeating a phrase), or lip synchronization tasks. Such fallback options may be pre-selected by the user through an accessibility profile, or triggered automatically by the system upon detecting pose compliance failure. The verification result from these alternative modalities may be weighted and incorporated into the overall identity assessment along with document analysis and facial recognition.

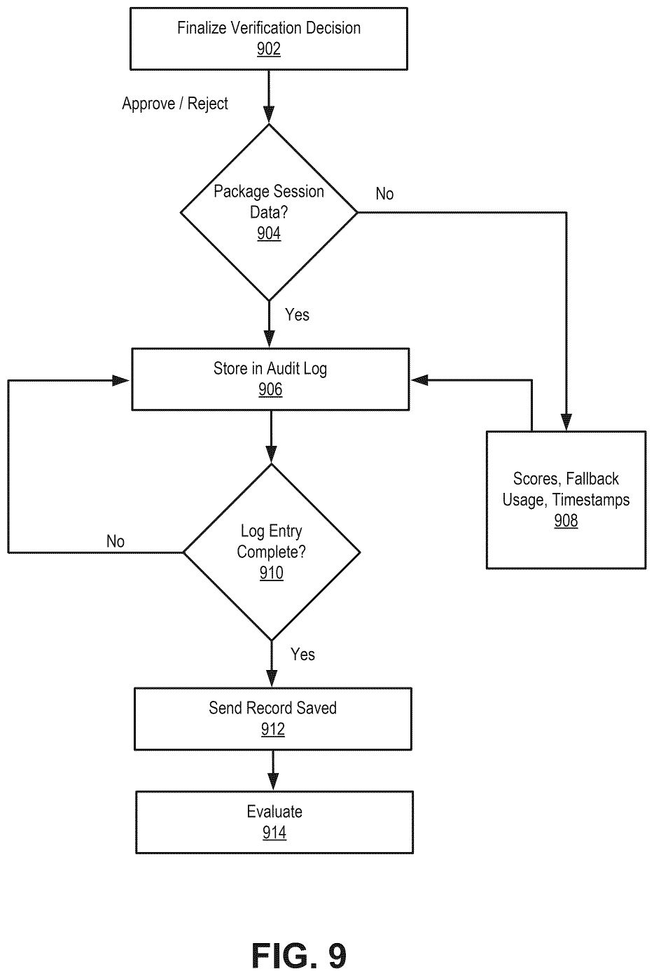

FIG. 9 illustrates a process flow for capturing and finalizing an audit log entry following an identity verification decision, according to some embodiments of the disclosed technology. This workflow is designed to ensure that each verification session-whether completed through automated scoring, fallback input, or manual review—is recorded with sufficient metadata to support traceability, regulatory compliance, and downstream analysis.

The process begins at step 902 when a verification decision has been finalized. This decision may reflect an automated approval or rejection based on aggregated confidence scores as described with reference to FIG. 6, or a reviewer-driven outcome as shown in FIG. 7. Once the outcome is determined, the system proceeds to step 904 to determine whether the relevant session data has already been packaged. The session data may include user-submitted inputs (e.g., document image, selfie, voice input), extracted metadata, verification scores, fallback activity, timestamps, reviewer notes, and any session-specific flags or audit annotations.

If the system determines that session data has not been packaged, the process branches to step 908, where it retrieves the relevant session materials. This may involve pulling data from various system modules, reconstructing intermediate scores, and normalizing fields such as timestamps, fallback path indicators, and reviewer inputs. The reconstructed data is then routed to step 906. If session data was already packaged at step 904, the system moves directly to step 906, where the audit record is stored. In some embodiments, the audit log may be written to a local database, encrypted file system, blockchain ledger, or third-party compliance service. The log entry may also include a hash or digital signature to ensure immutability.

Following storage, the system advances to step 910 to confirm whether the log entry was successfully completed. This may include verifying that the record contains all required fields, passes schema validation, and, optionally, satisfies cryptographic integrity checks. If the system determines that the log entry is incomplete or invalid, it returns to step 906 to attempt to re-store the entry with corrected or repackaged data. This retry loop ensures that a valid and complete audit record is eventually generated, even in the event of initial storage failure.

Once the system verifies that the log entry is complete, it proceeds to step 912, where a “Record Saved” confirmation is generated. This confirmation may trigger downstream actions, including signaling external systems that the verification process is closed, generating user-facing logs, or clearing transient session data. Finally, at step 914, the system evaluates whether additional action is required—such as retraining, alert escalation, or reviewer feedback logging—based on the outcome of the session. In some implementations, session records stored through this flow may be used to refine scoring thresholds, track reviewer consistency, or support audits of the overall identity verification system.

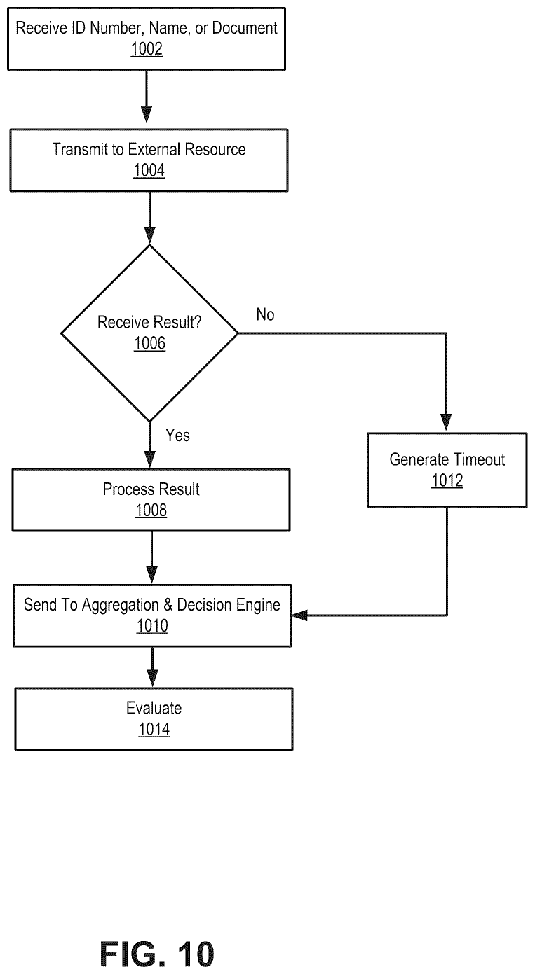

FIG. 10 illustrates a process flow for validating an identity verification input using one or more external resource systems, according to some embodiments of the disclosed technology. The system may query external databases, APIs, or third-party verification services to supplement internal scoring and support regulatory compliance, risk analysis, or enhanced fraud detection.

At step 1002, the system receives an identity-related data element that is to be externally validated. This may include a user-provided government-issued ID number, a full name and date of birth, a scanned document, or a structured field extracted from a prior parsing process, as described in FIG. 3. Once received, the system transmits the relevant data to one or more external resources at step 1004. External resources may include governmental databases, sanctions lists, credit bureaus, identity registries, public record databases, or third-party KYC vendors. In some embodiments, the external resource may be dynamically selected based on jurisdiction, document type, or service availability.

At decision step 1006, the system determines whether a result has been received from the external resource. The result may contain status codes, validation scores, entity matches, or flags such as “match found,” “invalid ID,” or “document expired.” If the result is received within a defined time window, the system proceeds to step 1008, where the response is parsed and normalized for integration with the internal verification pipeline. If no response is received within a timeout threshold, the system proceeds instead to step 1012, where a timeout event is generated and recorded. This timeout may affect the weighting of external verification in the final aggregation process or trigger a fallback rule.

At step 1010, either the normalized external result or the generated timeout event is transmitted to the aggregation and decision engine. This enables the external validation outcome to be factored into the broader scoring model alongside other metrics such as face similarity, pose compliance, document authenticity, and voice analysis, as previously described in FIG. 6.

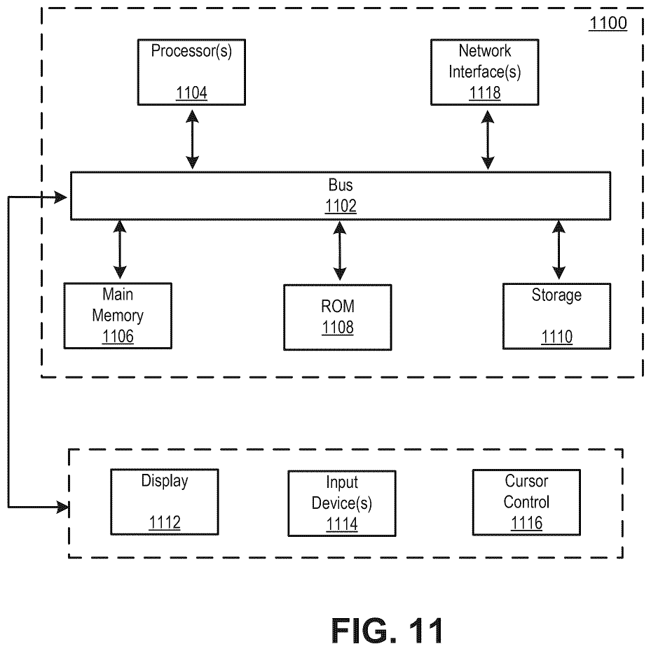

Finally, at step 1014, the system evaluates the combined result set, which now includes internal and external data, to determine whether to approve the user, flag the session for manual review, or escalate based on risk factors. In some embodiments, external validation failures may trigger enhanced due diligence workflows, whereas successful validation may reduce verification friction or raise internal confidence thresholds. Results from the external query may also be logged to the audit trail described in FIG. 9 for regulatory reporting and dispute resolution.

Where circuits are implemented in whole or in part using software, in one embodiment, these software elements can be implemented to operate with a computing or processing system capable of carrying out the functionality described with respect thereto. One such example computing system is shown in FIG. 11. Various embodiments are described in terms of this example-computing system 1100. After reading this description, it will become apparent to a person skilled in the relevant art how to implement the technology using other computing systems or architectures.

FIG. 11 depicts a block diagram of an example computer system 1100 in which various of the embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors and/or specialized graphical processors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such a SSD, magnetic disk, optical disk, or USB thumb drive (Flash drive), etc., is provided and coupled to bus 1102 for storing information and instructions.

The computer system 1100 may be coupled via bus 1102 to a display 1112, such as a transparent heads-up display (HUD) or an optical head-mounted display (OHMD), for displaying information to a computer user. An input device 1114, including a microphone, is coupled to bus 1102 for communicating information and command selections to processor 1104. An output device 1116, including a speaker, is coupled to bus 1102 for communicating instructions and messages to processor 1104.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, boy Java, Java, C or C++. A software component may be compiled and linked into an executable program, installed in a dynamic link library, or may be written in an interpreted programming language such as, for example, BASIC, Perl, or Python. Components may also be written in a database language such as SQL and/or handled via a database object such as a trigger or a constraint. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire, and fiber optics, including the wires that comprise bus 1102. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for verifying user identity in real time, the method comprising:
receiving, via a client device, an image of a government-issued identification document submitted by a user;
extracting user identification information from the identification document image using optical character recognition (OCR);
identifying and extracting a facial image from the identification document image;
prompting the user to capture a real-time selfie image via the client device;
analyzing the real-time selfie image for compliance with one or more randomized pose instructions;
comparing the extracted facial image to the selfie image using facial recognition to determine a similarity score; and
verifying the user's identity based at least on the similarity score.

2. The method of claim 1, wherein the government-issued identification document comprises at least one of a passport, a driver's license, or a national identity card.

3. The method of claim 1, wherein the extracted user identification information includes at least one of: name, date of birth, document number, or expiration date.

4. The method of claim 1, further comprising determining the authenticity of the identification document using layout analysis or detection of known security features.

5. The method of claim 1, wherein the prompt for the selfie includes a randomized instruction selected from a set of gestures, facial expressions, or head movements.

6. The method of claim 1, further comprising evaluating the selfie image for liveness to detect presentation attacks or spoofing attempts.

7. The method of claim 1, further comprising rejecting the user's identity verification if the similarity score is below a predetermined threshold.

8. The method of claim 1, further comprising logging the OCR-extracted data and similarity score to an identity verification database for audit and compliance.

9. The method of claim 1, wherein the comparison between the facial image and the selfie image is performed using a machine learning model comprising a neural network trained on biometric features.

10. The method of claim 1, further comprising notifying an administrator or third-party service if the verification fails or if the document is flagged as suspicious.

11. The method of claim 1, further comprising, in response to a failed pose compliance check, performing fallback verification using voice input or device motion patterns.

12. The method of claim 1, further comprising querying an external identity validation service using extracted document data, and adjusting the verification outcome based on the received response or a timeout condition.

13. A system for verifying user identity in real time, the system comprising:
a processor;
a memory coupled to the processor; and
a non-transitory computer-readable medium storing instructions that, when executed by the processor, cause the system to:
receive, via a client device, an image of a government-issued identification document submitted by a user;
extract user identification information from the identification document image using optical character recognition (OCR);
identify and extract a facial image from the identification document image;
prompt the user to capture a real-time selfie image including a randomized pose;
analyze the selfie image for compliance with the randomized pose instruction;
compare the extracted facial image to the selfie image using facial recognition to generate a similarity score; and
verify the user's identity based at least on the similarity score.

14. The system of claim 13, wherein the identification document comprises at least one of: a passport, a driver's license, or a government-issued identity card.

15. The system of claim 13, wherein the instructions further cause the system to determine the authenticity of the identification document based on expected layout patterns or known security features.

16. The system of claim 13, wherein the randomized pose instruction comprises a gesture, facial expression, or head movement selected from a predefined set.

17. The system of claim 13, wherein the instructions further cause the system to evaluate the selfie image for liveness using one or more anti-spoofing techniques.

18. The system of claim 13, wherein the instructions further cause the system to log the extracted identification data and the verification result to a persistent identity verification database.

19. The system of claim 13, wherein the facial recognition comparison is performed using a neural network trained on biometric features.

20. The system of claim 13, wherein the instructions further cause the system to deny access or trigger an alert if the similarity score falls below a predefined threshold.
